(19) United States
(12) Patent Application Publication
(10) Pub. No.: US 2020/0182704 A1
(43) Pub. Date: Jun. 11, 2020

(54) SYSTEMS AND METHODS OF VERIFYING INSTALLATION OF A RESISTANCE TEMPERATURE DETECTOR IN A THERMOWELL

(71) Applicant: Analysis and Measurement Services Corporation, Knoxville, TN (US)

(72) Inventor: Alexander Hashem Hashemian, Knoxville, TN (US)

(21) Appl. No.: 16/696,339

(22) Filed: Nov. 26, 2019

Related U.S. Application Data
(60) Provisional application No. 62/771,377, filed on Nov. 26, 2018.

(51) Int. Cl. G01K 1/14; G01K 1/02

(52) U.S. Cl. CPC G01K 1/14; G01K 1/08; G01K 1/02

(57) ABSTRACT

Systems and methods of verifying installation of a temperature sensor such as a resistance temperature detector (RTD) in a thermowell independent of the surrounding conditions using a Loop Current Step Response (LCSR) test method to obtain thermal response data for the installed sensor and analyzing the resulting data to determine installation quality of the sensor in the thermowell and estimate sensor response time or time constant at a user-specified condition.

### CROSS-REFERENCE TO RELATED APPLICATIONS

This application claims priority from U.S. Provisional Application No. 62/771,377 filed on Nov. 26, 2018.

### BACKGROUND OF THE INVENTION

### 1. Field of the Invention

The present general inventive concept relates to an in-situ response time test system and method for temperature sensors such as resistance temperature detectors (RTDs) or thermocouples, known as the Loop Current Step Response (LCSR) test method. An analysis technique is presented herein that allows for verification of the proper installation of an RTD in a thermowell independent of the surrounding process conditions and is applicable to any RTD and thermowell.

The analysis technique according to the present general inventive concept provides qualitative insight into the air gap that may exist between an RTD and thermowell. The magnitude of the air gap is optimized to enable fast thermal response time of the RTD while still allowing sufficient space for thermal expansion.

### 2. Description of Related Art

For many industrial plant applications, process temperatures measured by RTDs provide critical data used by the plant control and safety systems. In some plant applications, RTDs utilize thermowells for protection against high-temperature, high-pressure, or corrosive processes. Thermowell-installed RTDs are designed to mate well with their corresponding thermowells by optimizing the air gap that may exist between the RTD and thermowell in order to enable a fast response while still allowing space for thermal expansion and contraction. However, for transient applications requiring sensors with fast response times, an RTD installed improperly in a thermowell can severely compromise the dynamic performance of the RTD and thus affect plant control and safety. In plants with sensor response time requirements, it is necessary to confirm that a newly installed RTD has been well installed in its thermowell and fast enough as installed to meet the plant technical specifications required for operation during a plant outage prior to startup. In addition, subsequent periodic surveillance testing may be performed to verify that the RTD response has not degraded over time and still meets the response time requirements of the plant.

The conventional method for determining the response time or time constant of a temperature sensor is referred to as the plunge test which involves measuring the time required for the sensor output to achieve 63.2% of its final value after a step change in temperature is imposed on the surface of the sensor. A step change in temperature is imposed in a laboratory test environment by suddenly drawing the sensor from one medium at an initial temperature to another medium at a different temperature. However, the plunge test method is deficient in that it cannot be performed on an RTD after it has been installed in a thermowell in a plant and thus cannot characterize RTD installation quality.

In order to address the inherent limitations of the plunge test, the LCSR test method was developed to enable response time testing of installed temperature sensors such as RTDs. The LCSR in-situ test method is based on heating a temperature sensor internally by applying a step change in electrical current applied to the lead wires of the sensor. The current heats the sensing element of the sensor and its temperature rises as a function of the magnitude of the supplied current and the rate of heat transfer between the sensor and its surroundings. The resulting LCSR test data can be analyzed to determine time constant of the sensor. The time constant of a sensor provides a quantitative metric of how fast or slow the sensor responds to a step change in ambient conditions. The time constant of a sensor is a function of its mass, heat capacity, and surface area. However, the time constant of a sensor is also a function of several other variables including the surrounding process medium, temperature, and flow rate, in addition to the air gap between the RTD and thermowell.

Conventional LCSR data collection and analysis within a plant requires the RTD under test to be at steady-state or normal in-service process conditions for the duration of the test which can take up to one hour to complete and involves removing the RTD from service. During this time, the RTD cannot provide temperature data to plant operators or to control and safety systems. If it is determined after the test is complete that the RTD's response is too slow and requires reinstallation in the thermowell, the plant must reach a condition to allow the safe manual reworking of the RTD in the thermowell. Subsequent retesting, reworking, or replacement are repeated as necessary until the sensor has been made to satisfy the response time requirements as defined by the technical specifications for safe plant operation. As a result, this process may become very time consuming and costly, especially for applications in nuclear power plants including small modular reactors.

Therefore, what is desired is an improved LCSR data collection and analysis technique that can quickly and conveniently characterize the installation quality of an RTD in a thermowell at any process condition.

### BRIEF SUMMARY OF THE INVENTION

Example embodiments of the present general inventive concept provide an improved data collection and analysis technique that when used in conjunction with a Loop Current Step Response (LCSR) test method provides an in-situ means to adequately verify the installation of a temperature sensor such as a resistance temperature detector (RTD) in a thermowell independent of the effects of the surrounding environment.

Example embodiments of the present general inventive concept also relate to a data acquisition and processing system, in the form of hardware and software, used in conjunction with an LCSR test method to verify the installation of a sensor in a thermowell, to identify the sensor's time constant at the tested conditions, and to output an estimate of the sensor's time constant as installed in another user-specified process condition.

### BRIEF DESCRIPTION OF THE DRAWINGS

The above-mentioned features of the present general inventive concept will become more clearly understood from the following detailed description of the invention read together with the drawings in which:

FIG. 1a is a schematic view of an RTD-in-thermowell assembly according to an exemplary embodiment of a typical flat-tip thermowell-installed RTD and thermowell with an air gap between the RTD and thermowell;

FIG. 1b is a schematic view of an RTD-in-thermowell assembly according to an exemplary embodiment of a typical tapered-tip thermowell-installed RTD and thermowell with an air gap between the RTD and thermowell;

FIG. 2a is a schematic view of an RTD-in-thermowell assembly according to an exemplary embodiment of a typical flat-tip RTD and thermowell with a large air gap between the RTD and thermowell;

FIG. 2b is a schematic view of an RTD-in-thermowell assembly according to an exemplary embodiment of a typical flat-tip RTD and thermowell with a small air gap between the RTD and thermowell;

FIG. 3 is a graph of comparative RTD-in-thermowell LCSR response data that is a function of the air gap between the RTD and thermowell as illustrated in FIGS. 2a and 2b; and

FIG. 4 is a block diagram of one embodiment of the proposed invention.

### DETAILED DESCRIPTION OF THE INVENTION

Methods and techniques developed according to example embodiments of the present general inventive concept are capable of evaluating the quality of the installation of a temperature sensor such as a resistance temperature detector (RTD) in a thermowell based on analyzing Loop Current Step Response (LCSR) response data. The LCSR data analysis may be performed by a data acquisition and processing system with accompanying software packages to characterize installation quality and output estimates of sensor response time or time constant at other user-specified process conditions. The system may contain a database of information including sensor material properties, physical dimensions, and heat transfer equations in order to accurately predict sensor response time or time constant at various user-specified conditions. The system display may indicate to the user (via colored symbols, dialogues, or another means) that a sensor has not been well installed in its respective thermowell. A retest may be performed and processed with the initial data to compare the results and aid the user in troubleshooting the installation of the sensor in the thermowell.

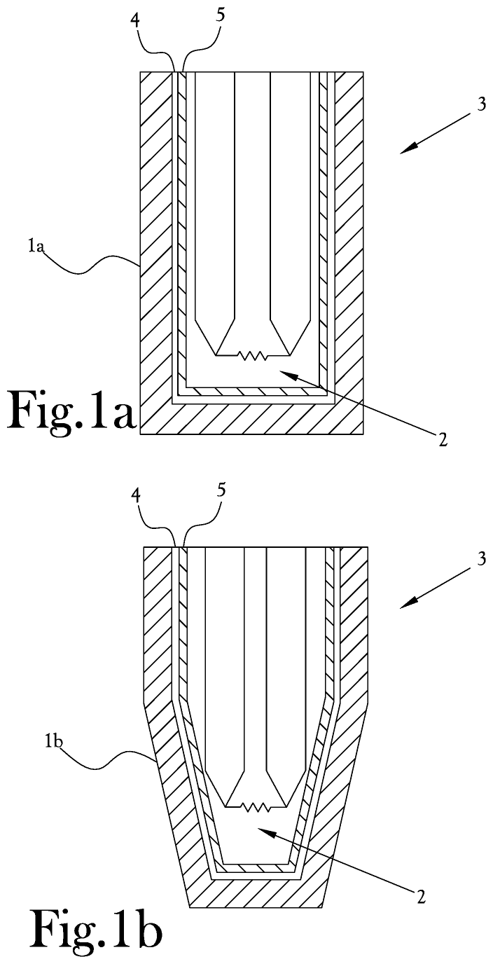

FIGS. 1a and 1b illustrate two possible configurations of an RTD-in-thermowell assembly 3. For demonstrative purposes, an RTD 5 having a single sensing element 2 is shown housed within a flat-tip thermowell 1a in FIG. 1a and a tapered-tip thermowell 1b in FIG. 1b. As shown in FIGS. 1a and 1b, the RTD-in-thermowell assembly 3 also includes an air gap 4 between an inner surface of the thermowell 1 and an outer surface of the RTD 5. The thermowell 1 and the air gap 4 provide protection to the RTD 5 from damage by isolating the RTD 5 from direct contact with the environment and accommodating for thermal expansion and contraction that may stress and damage the sensing element 2; however, this protection also insulates the RTD 5 from the surrounding environment and thus increases the sensor response time or time constant. The response time is the amount of time it takes the temperature sensor to observe a sudden change in temperature. For transient applications that require fast-response thermowell-installed RTDs, it is necessary to minimize the air gap to ensure a short response time while still allowing sufficient space for thermal expansion and contraction.

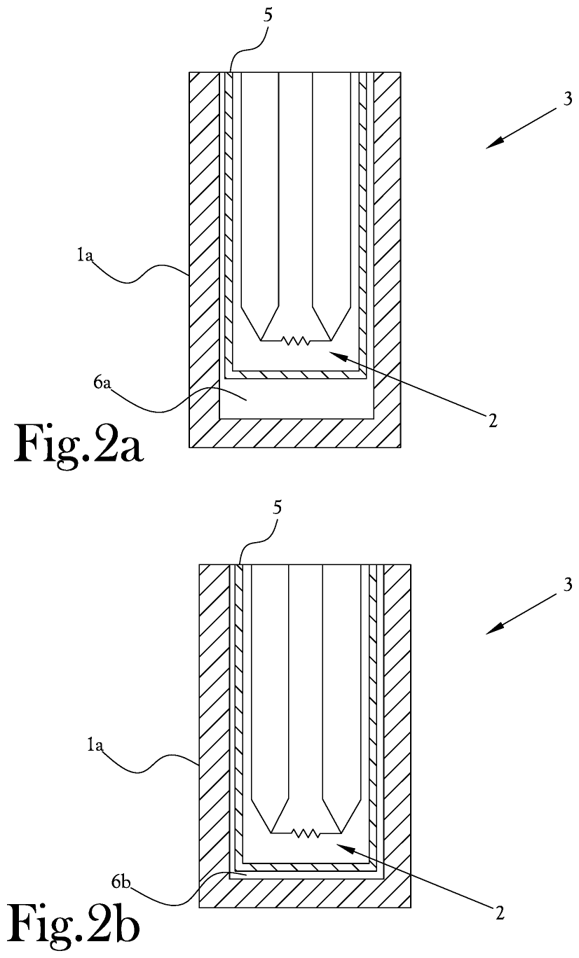

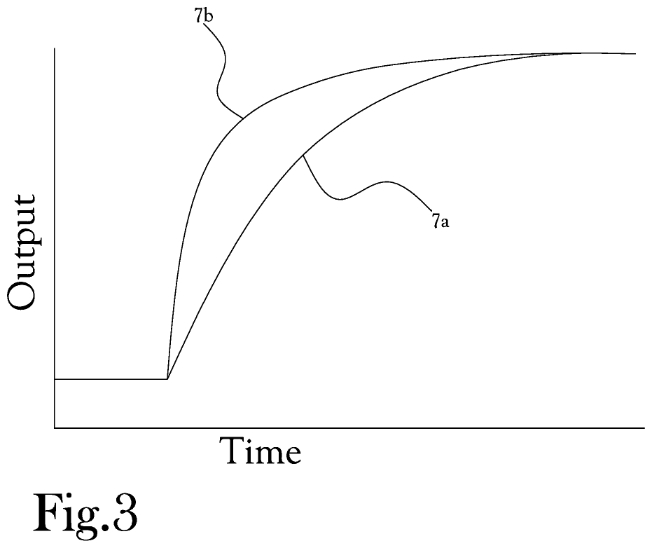

FIGS. 2a and 2 each illustrate an RTD-in-thermowell assembly 3 with a flat-tip RTD 5 and thermowell 1a. In FIG. 2a, there is a large air gap 6a between the RTD 5 and thermowell 1a. In FIG. 2b, there is a small air gap 6b between the RTD 5 and thermowell 1a. In FIG. 3, LCSR data as specified by the present invention is plotted corresponding to the RTD-in-thermowell assemblies 3 from FIGS. 2a and 2b. The LCSR data corresponding to the RTD-in-thermowell assembly 3 illustrated in FIG. 2a is the slow transient 7a, and the LCSR data corresponding to the RTD-in-thermowell assembly 3 in FIG. 2b is shown as the fast transient 7b.

Conventional LCSR data collection and analysis requires test data to be collected at steady-state process conditions for a sufficiently long time so as to allow the RTD to reach its constant final temperature. Many test data sets are collected similarly and averaged to produce a smooth transient that may be analyzed to determine the sensor response time. This data collection and analysis process can take up to an hour to perform. The response as determined from this process takes into account all variables that affect the response of the sensor (i.e. process conditions, physical properties of the sensor, and the air gap between the RTD and thermowell). However, the RTD installation quality cannot be verified with this approach unless the air gap between the RTD and thermowell is the dominant variable in the response equation, which is the case only when the greatest resistance to heat transfer occurs as a result of the air gap between the RTD and thermowell. In some applications and processes, it may be possible to control the surrounding conditions to force the air gap to become the source of greatest resistance to heat transfer and thus the dominating variable (e.g. high fluid flow rates to improve convection heat transfer between the outside wall of the thermowell and the surroundings). In many cases, this is not possible or practical.

The present invention provides a quick and easy method for characterizing the air gap between the RTD and thermowell and verifying the installation of an RTD in a thermowell without the need to control the surrounding process conditions. In addition, the data analysis method of the present invention may be applied to estimate sensor response time or time constant at another user-specified condition.

The present invention involves collecting LCSR data at a fast sampling rate (e.g. more than 100 samples per second) for a short time period (e.g. less than 10 seconds) using a small amount of electrical current (generally less than 50 mA). Subsequent test data sets may be collected if desired. The exact values of the test parameters (i.e. sampling rate, test period, current) depend on the application and RTD specifications. In the early (transient) time domain of the LCSR test, heat generated via Joule heating is dissipated from the RTD sensing element and transferred from the RTD to the thermowell. The resulting response data in the early time domain of the LCSR test is a function of the physical properties of the RTD, the physical properties of the thermowell, and the interface (i.e. air gap) between the RTD and thermowell. Among these variables, the air gap is the only one that may be modified once the RTD and thermowell have been selected by the end user. In the later time domain of the LCSR data, the heat continues to transfer through the wall of thermowell and ultimately dissipates to the surroundings. Therefore, the response of the RTD in the later time domain of the LCSR test is affected by the surrounding conditions (i.e. process medium, ambient temperature, fluid flow rate, etc.) which can mask the effect of the air gap on response and make it difficult to adequately verify RTD installation quality. The present innovation provides an LCSR data collection and analysis technique that characterizes the heat transfer phenomenon that is internal to the RTD-in-thermowell assembly (i.e. from the RTD sensing element to the thermowell boundary) in order to characterize the air gap between the RTD and thermowell and verify RTD installation. In addition, the present innovation includes a data acquisition and processing system specifically configured to analyze LCSR data and estimate sensor response time or time constant at other user-specified process conditions. This innovation is especially beneficial for industrial plant maintenance activities in which an RTD may be installed in a thermowell at process conditions that differ greatly from the process conditions experienced during plant operation. As a result, this technology saves time and resources to ensure adequate RTD installation in a thermowell.

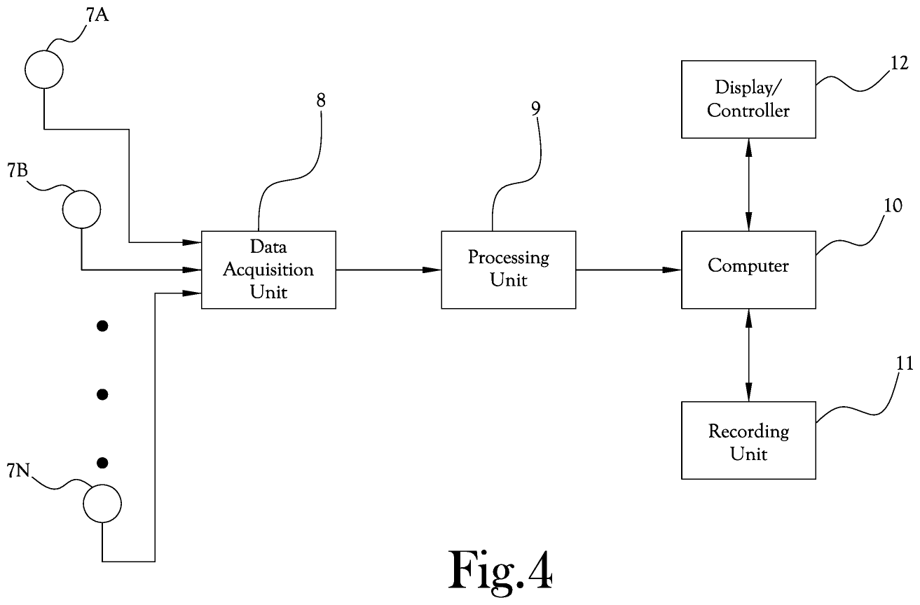

FIG. 4 illustrates an embodiment of the present invention. A plurality of temperature sensors such as RTDs (7a, 7b, . . . 7n) may be connected to a multi-channel data acquisition unit 8 to collect temperature sensor signals before, during, and after the transient phenomenon (period) of the LCSR test. A data processing unit 9 compares the received temperature signals during the transient phenomenon of the LCSR test to predetermined reference data to determine characteristics of an air gap between the outer surface of each temperature sensor and the inner surface of its corresponding thermowell based on magnitude, frequency, and/or phase differences between the recorded data and the predetermined reference data. A computer 10 may be incorporated into the system to provide data to a recording unit 11 and a display/controller 12 so as to, for example, output/display a time constant of the RTD and/or output/display results of the data processing compare and determine operations to a user.

As described and illustrated herein, example embodiments of the present general inventive concept provide a method of verifying installation of a temperature sensor in a thermowell, including conducting a Loop Current Step Response (LCSR) test on a thermowell-installed resistance temperature detector (RTD) to obtain LCSR thermal response data, recording obtained LCSR thermal response data within a computer readable storage medium, analyzing the LCSR thermal response data, and identifying effect of an air gap between the RTD and thermowell on RTD response time based on recorded LCSR thermal response data.

The method can include estimating the RTD response time of the RTD as installed in the thermowell at a user-specified condition. The recording step can occurs during an early time domain of the LCSR test.

The method can include comparing recorded LCSR data to predetermined reference data to verify installation quality of the RTD in the thermowell.

Example embodiments of the present general inventive concept can be achieved with a data acquisition device configured to be coupled to a temperature sensor such as an RTD to receive signals that can be used to verify the installation of the sensor in a thermowell and estimate the response time or time constant of the sensor at a user-specified condition.

Example embodiments of the present general inventive concept can also be achieved by a system of verifying installation of a sensor in a thermowell, including a data acquisition unit connected to one or more thermowell-installed temperature sensors, the data acquisition unit being configured to collect temperature signal data before, during, and after a transient period of a Loop Current Step Response (LCSR) test on the one or more temperature sensors, a data processing unit configured to compare collected temperature signal data during the transient period of the LCSR test to predetermined reference data, and to determine characteristics of an air gap between an outer surface of each temperature sensor and an inner surface of its corresponding thermowell based on magnitude, frequency, and/or phase differences between the recorded data and the predetermined reference data, and a computer configured to provide collected temperature signal data to a recording unit and a display/controller. For example, the system display may indicate to the user (via colored symbols, dialogues, or other visual or audible representations) that a sensor has not been well installed in its respective thermowell.

The present general inventive concept can be embodied as computer-readable codes configured to run on a testing device to instruct the testing device to perform the data transfer operations. The computer readable-codes can be embodied on a computer-readable storage medium for installation on the described hardware. The computer-readable medium can include a computer-readable recording medium and a computer-readable transmission medium. The computer-readable recording medium can be any data storage device that can store data as a program which can be thereafter read by a computer system. Examples of the computer-readable recording medium include read-only memory (ROM), random-access memory (RAM), CD-ROMs, DVDs, jump drives, magnetic tapes, floppy disks, and other optical or solid state data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission over a network). Also, functional programs, codes, and code segments to accomplish embodiments of the present general inventive concept can be easily construed by programmers skilled in the art to which the present general inventive concept pertains after having read the present disclosure.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While example embodiments have been illustrated and described, it will be understood that the present general inventive concept is not intended to limit the disclosure, but rather it is intended to cover all modifications and alternate devices and methods falling within the spirit and the scope of the invention as defined in the appended claims.

What is claimed is:

1. A method of verifying installation of a temperature sensor in a thermowell, the method comprising:
conducting a Loop Current Step Response (LCSR) test on a thermowell-installed resistance temperature detector (RTD) to obtain LCSR thermal response data;
recording obtained LCSR thermal response data within a storage medium;
analyzing the LCSR thermal response data; and
identifying the effect of an air gap between the RTD and thermowell on RTD response time based on recorded LCSR thermal response data.

2. The method of claim 1, further comprising estimating the RTD response time of the RTD as installed in the thermowell at a user-specified condition.

3. The method of claim 1, wherein the recording step occurs during an early time domain of the LCSR test.

4. The method of claim 2, further comprising comparing recorded LCSR data to predetermined reference data to verify installation quality of the RTD in the thermowell.

5. A data acquisition device configured to be coupled to an RTD temperature sensor to receive signals so as to verify the installation of the sensor in a thermowell and estimate the response time or time constant of the sensor at a user-specified condition, as illustrated and described herein.

6. A system of verifying installation of a sensor in a thermowell, comprising:
a data acquisition unit connected to one or more thermowell-installed temperature sensors, the data acquisition unit being configured to collect temperature signal data before, during, and after a transient period of a Loop Current Step Response (LCSR) test on the one or more temperature sensors;
a data processing unit configured to compare collected temperature signal data during the transient period of the LCSR test to predetermined reference data, and to determine characteristics of an air gap between an outer surface of each temperature sensor and an inner surface of its corresponding thermowell based on magnitude, frequency, and/or phase differences between the recorded data and the predetermined reference data; and
a computer configured to output visual representations of results data to a recording unit and/or a display/controller.
